(19) United States
(12) Patent Application Publication
(10) Pub. No.: US 2008/0148268 A1
(43) Pub. Date: Jun. 19, 2008

(54) DATA PROCESSING APPARATUS, DATA PROCESSING SYSTEM, METHOD THEREFOR, AND PROGRAM

(75) Inventor: Yasuo Hirouchi, Yamato-shi (JP)

Correspondence Address: ROSSI, KIMMS & McDOWELL LLP., P.O. BOX 826, ASHBURN, VA, 20146-0826, US

(73) Assignee: CANON KABUSHIKI KAISHA, Tokyo (JP)

(21) Appl. No.: 11/955,941

(22) Filed: Dec. 13, 2007

(30) Foreign Application Priority Data
Dec. 15, 2006 (JP) 2006-339065

(51) Int. Cl. G06F 9/46

(52) U.S. Cl. 718/103

(57) ABSTRACT

A server acquires data representing the number of jobs on the daily and hourly basis for several weeks held by itself and by clients. An apparatus for executing scheduling calculates the total number of jobs on the daily basis from the acquired data representing the number of jobs on the daily and hourly basis for several weeks and determines the order in ascending order of the total number of jobs on the daily basis. The apparatus searches for a time period with long idle time sequentially from the day with the minimum total number of jobs. Regarding the target day to search for a time period with long idle time, it is determined whether a time period of 3 consecutive hrs without job is present. If a time period of 3 consecutive hrs without job is present, the middle time of the time period is scheduled as a firmware update time period, and firmware update is registered.

### BACKGROUND OF THE INVENTION

1. Field of the Invention

The present invention relates to a data processing apparatus, a data processing system, a method therefore, and a program and, more particularly, to a technique of determining a program update schedule.

2. Description of the Related Art

Conventionally, a technique of causing a server in a remote place to update firmware installed in a data processing apparatus on a network is known (e.g., Japanese Patent Laid-Open No. 07-248913). In this technique, the server manages facility information and firmware version information. The server automatically selects a data processing apparatus as a firmware update target on the basis of the facility information and information such as a firmware release date and time. The server transmits firmware and a scenario representing an update procedure to the data processing apparatus of the update target. The data processing apparatus updates the firmware on the basis of the received scenario.

In the firmware update technique described in patent reference 1, however, if a plurality of data processing apparatuses of the same model and same version are present, they update firmware simultaneously. In this case, the plurality of data processing apparatuses become unavailable simultaneously and greatly impede user's operations during firmware update. To reduce the impediment of the user's operations, it is preferable to take the job execution state in each data processing apparatus into consideration.

### SUMMARY OF THE INVENTION

The present invention enables to reduce impediment of user's operations in executing program update in a data processing apparatus.

According to the present invention, the foregoing problem is solved by providing a server apparatus for transmitting data necessary for program update to a client apparatus comprising an acquisition unit configured to acquire, from the client apparatus, job execution status representing the status of jobs executed in each of a plurality of periods of time by the client apparatus, and a scheduling unit configured to determine a schedule of program update in the client apparatus on the basis of the job execution status acquired by the acquisition unit.

Further features of the present invention will become apparent from the following description of exemplary embodiments with reference to the attached drawings.

### BRIEF DESCRIPTION OF THE DRAWINGS

FIG. 1 is a block diagram showing the internal arrangement of a data processing apparatus according to the first embodiment;

FIG. 2 is a view for explaining program update scheduling executed by an image processing apparatus 100 in FIG. 1;

FIG. 3 is a view for explaining program update scheduling executed by the image processing apparatus 100 in FIG. 1;

FIG. 4 is a flowchart illustrating a firmware update scheduling process executed by a server 201 in FIG. 3;

FIG. 5 is a flowchart illustrating a firmware update scheduling process executed by the server 201 in FIG. 3;

FIG. 6 is a table showing data representing the number of jobs on the daily and hourly basis for several weeks, which is used in step S403 of FIG. 4;

FIG. 7 is a table showing a firmware update schedule used in step S406 of FIG. 5;

FIG. 8 is a table showing a firmware update schedule made by the scheduling process in FIGS. 4 and 5;

FIG. 9 is a view for explaining a firmware update process executed by the server 201 and clients 202 to 204 in FIG. 3;

FIG. 10 is a flowchart illustrating the firmware update process executed by the server 201 and clients 202 to 204 in FIG. 3;

FIG. 11 is a view showing display to notify a user that an apparatus displayed in step S902 of FIG. 10 is to become unavailable;

FIG. 12 is a flowchart illustrating a firmware update scheduling process according to the second embodiment;

FIG. 13 is a flowchart illustrating a firmware update scheduling process according to the second embodiment;

FIG. 14 is a flowchart illustrating a firmware update scheduling process according to the second embodiment;

FIG. 15 is a flowchart illustrating a firmware update scheduling process according to the second embodiment;

FIG. 16 is a flowchart illustrating a firmware update scheduling process according to the second embodiment;

FIG. 17 is a flowchart illustrating a firmware update process according to the third embodiment;

FIG. 18 is a table showing a firmware update schedule used in the firmware update process in FIG. 17;

FIG. 19 is a view for explaining the status columns of the schedule in FIG. 18;

FIG. 20 is a flowchart illustrating a rescheduling process executed by the server 201;

FIG. 21 is a flowchart illustrating a wakeup process of the clients 202 to 204; and

FIG. 22 is a flowchart illustrating a wakeup process of the server 201.

### DESCRIPTION OF THE EMBODIMENTS

Preferred embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

### First Embodiment

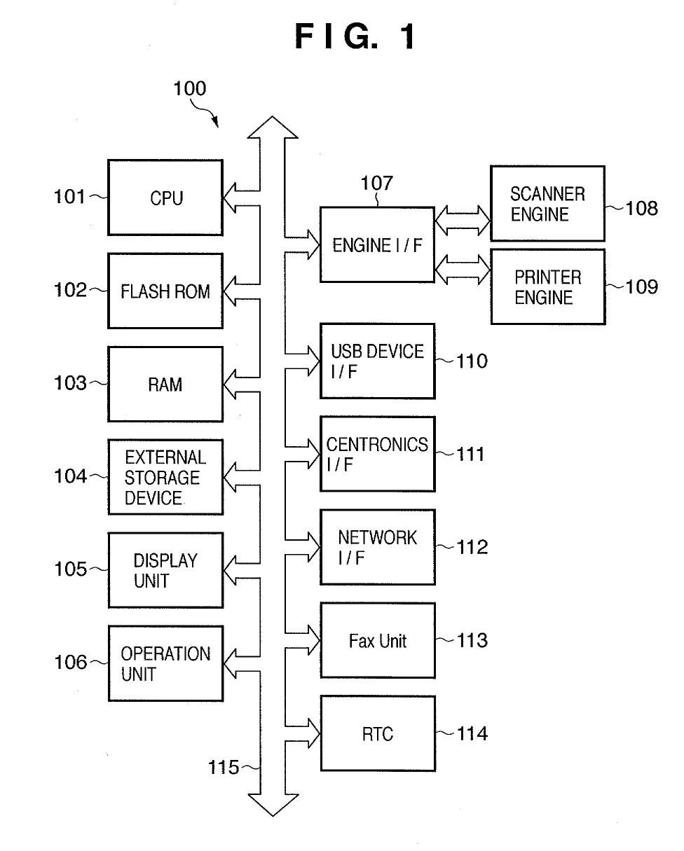

FIG. 1 is a block diagram showing the internal arrangement of a data processing apparatus according to the first embodiment.

Referring to FIG. 1, an image processing apparatus 100 (data processing apparatus) comprises a CPU (Central Processing Unit) 101, flash ROM 102, RAM (Random Access Memory) 103, external storage device 104, display unit 105, and operation unit 106. The image processing apparatus 100 also comprises an engine I/F (interface) 107, USB device I/F 110, centronics I/F 111, network I/F 112, FAX Unit 113, and RTC (Real Time Clock) 114. These units are connected to each other via a system bus 115. The image processing apparatus 100 also comprises a scanner engine 108 and printer engine 109 which are connected to the engine I/F 107.

The CPU 101 executes control of the entire image processing apparatus 100 and an arithmetic process. The flash ROM 102 is a read only memory serving as a storage area which stores a system activation program, printer engine control program, character data, and character code information. The flash ROM 102 usually operates as a ROM. However, a program enables to electrically erase/write data from/in the flash ROM 102.

The RAM 103 is a data storage area without use restriction and serves as a PDL data rasterizing area. Additionally, programs and data are loaded and executed in the RAM 103 for various processes such as conversion from PDL data to DL data and conversion from DL data to bitmap data. The RAM 103 also serves as a data area which records the number of jobs executed on the daily and hourly basis.

The external storage device 104 including, e.g., a hard disk spools a print job received by the image processing apparatus 100, stores print data of a print job, and serves as a work area. The external storage device 104 also holds, as files, the above-described data that is rasterized on the RAM 103 and records the number of jobs executed on the daily and hourly basis. The external storage device 104 also holds data for several weeks as files.

The display unit 105 including, e.g., a liquid crystal display panel has a VRAM to rasterize a display image. The display unit 105 displays the set state of the image processing apparatus 100, the current process state in the image processing apparatus 100, an error state, and notice about firmware update. The operation unit 106 has an operation portion including hard keys and a touch panel attached to the surface of the display unit 105. The operation unit 106 changes the settings of the image processing apparatus 100.

The engine I/F 107 transmits or receives commands and data to control the scanner engine 108 and printer engine 109. The USB device I/F 110 is connected to an external host to, e.g., receive PDL data.

The centronics I/F 111 is connected to an external host. The network I/F 112 is connected to an external host, external server, or Internet. The network I/F 112 is also used to, e.g., receive PDL data from an external host or transmit/receive firmware. The FAX Unit 113 is used for FAX transmission and reception.

The RTC 114 incorporating a battery and a timepiece function provides a time function necessary for activating the OS of the system. The RTC 114 also has a timer and alarm function and causes an interrupt at a designated time. For example, the RTC 114 can generate a trigger to activate the system in a low power state.

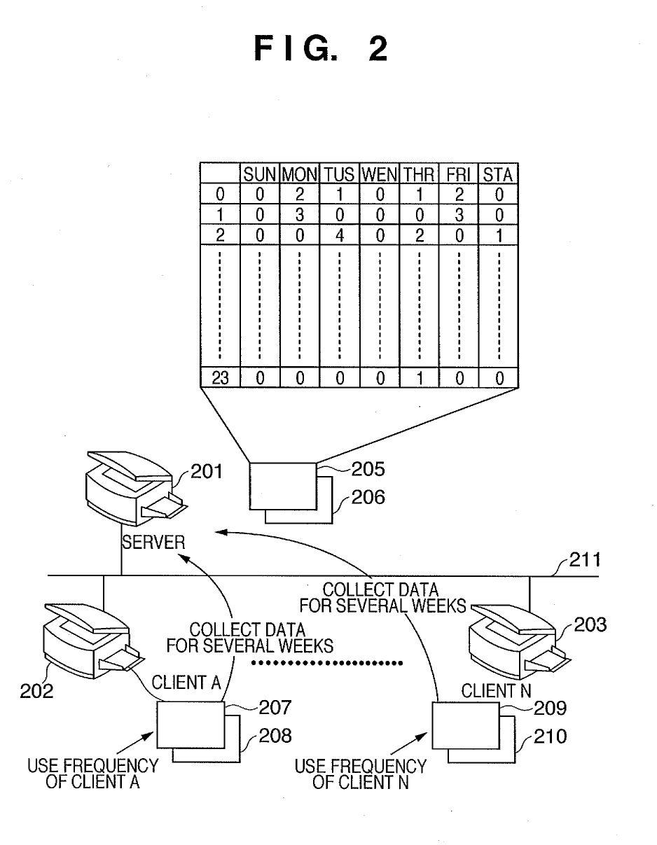

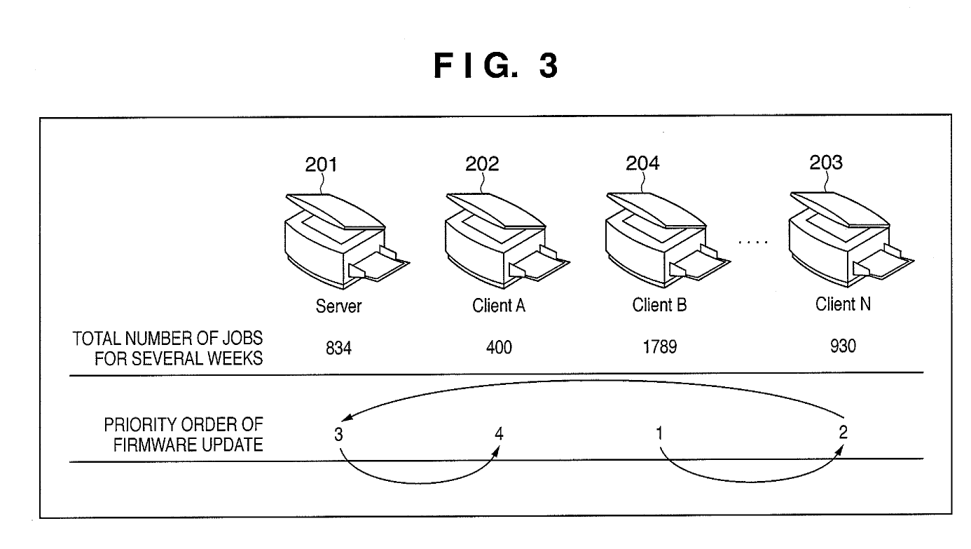

FIGS. 2 and 3 are views for explaining program update scheduling executed by the image processing apparatus 100 in FIG. 1. Firmware will be described below as an example of a program. However, it may be software.

Referring to FIG. 2, a server 201 is an arbitrary one of a plurality of image processing apparatuses 100, which serves as a server. The server 201 holds data representing the number of jobs on the daily and hourly basis for several weeks, like data 205 of this week and data 206 of last week. The data need only represent the number of jobs executed during every specific time period and may represent the number of jobs in each week, each day of the week, or every 10 min.

Each of clients 202 and 203 is one of the plurality of image processing apparatuses 100, which operates as a client. The client 202 holds data representing the number of jobs on the daily and hourly basis for several weeks, like data 207 of this week and data 208 of last week. The client 203 holds data representing the number of jobs on the daily and hourly basis for several weeks, like data 209 of this week and data 210 of last week.

The server 201 and clients 202 and 203 are connected to each other through a network 211.

Referring to FIG. 3, a client 204 is one of the plurality of image processing apparatuses 100, which operates as a client. The client 204 also holds data representing the number of jobs on the daily and hourly basis for several weeks, like data of this week and data of last week described in FIG. 2.

The total number of jobs indicates the sum of job counts in the server and clients for several weeks. The priority order of firmware update is determined on the basis of the total number of jobs for several weeks. This indicates the priority order of firmware update scheduling.

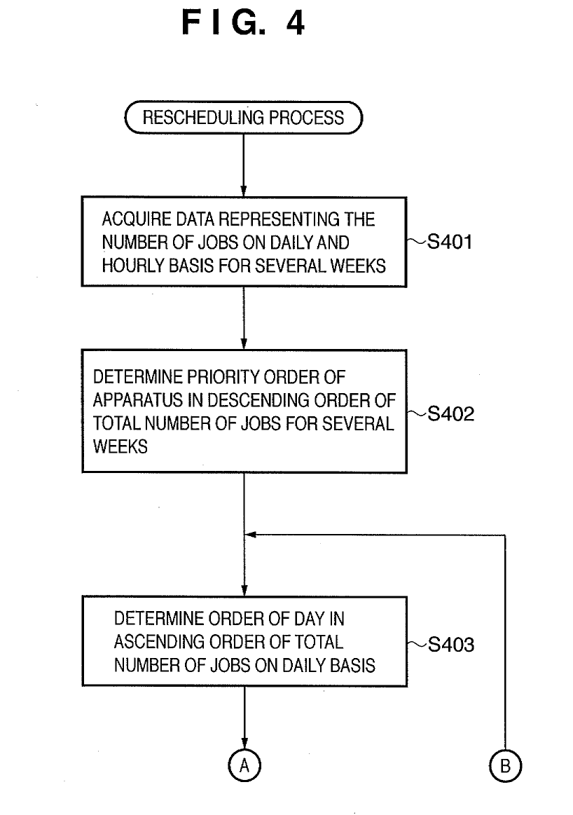

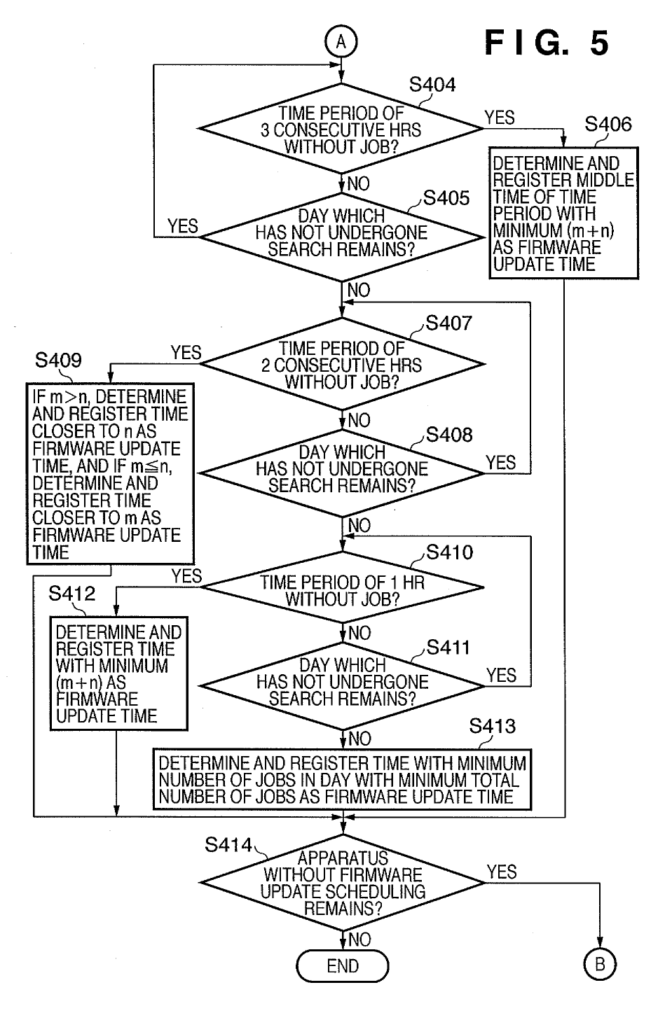

FIGS. 4 and 5 are flowcharts illustrating a firmware update scheduling process executed by the server 201 in FIG. 3. This scheduling process is done by causing the CPU 101 of the server 201 to execute a program based on the flowcharts in FIGS. 4 and 5.

Referring to FIG. 4, the server 201 acquires data representing the number of jobs on the daily and hourly basis for several weeks held by itself and by the clients 202 to 204 (step S401). The server 201 calculates the total number of jobs in each apparatus for several weeks and determines the priority order of firmware update in descending order of the total number of jobs for several weeks (step S402). FIG. 3 shows an example of the determined priority order. An apparatus with a large total number of jobs for several weeks is frequently used by users. Such an apparatus is supposed to have little idle time without job execution. Hence, firmware update scheduling is performed preferentially for the apparatus with the large total number of jobs for several weeks.

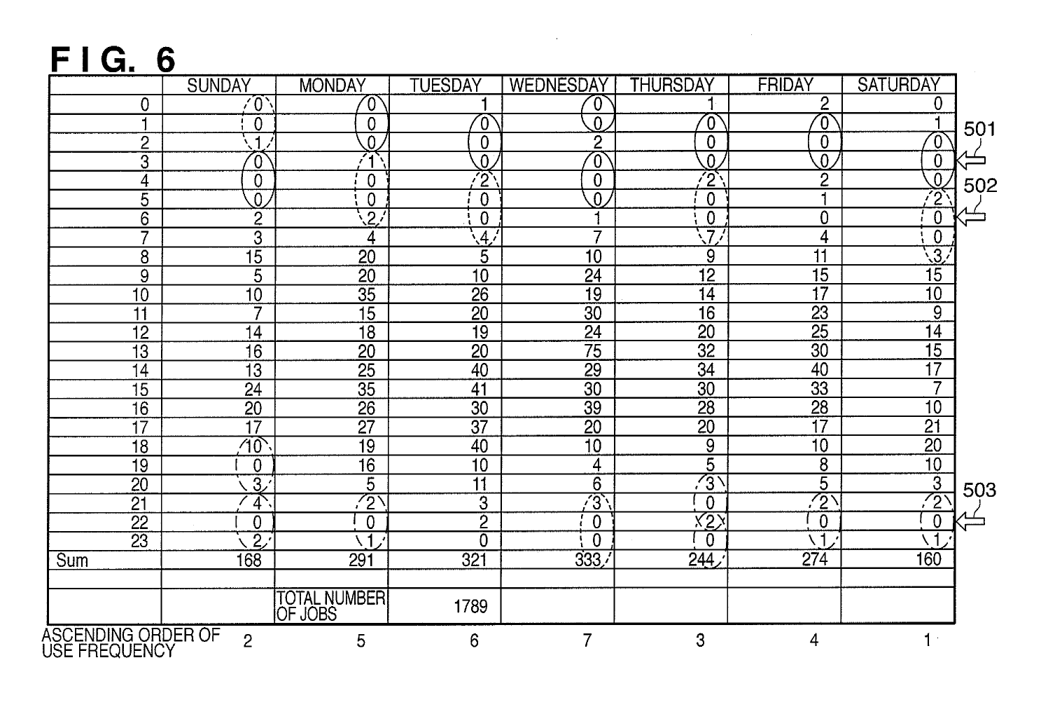

Next, firmware update scheduling is done sequentially from the apparatus with the largest total number of jobs for several weeks (i.e., the apparatus with the highest priority order of firmware update). First, for the scheduling target apparatus, the total number of jobs on the daily basis is calculated from the acquired data representing the number of jobs on the daily and hourly basis for several weeks, as shown in FIG. 6. An order is determined in ascending order of the total number of jobs on the daily basis (step S403). This is because a day with a small total number of jobs can ensure long idle time at a high probability. In FIG. 6, Saturday with the smallest total number of jobs is given order “1”.

After the calculation in step S403, a time period with long idle time is searched for sequentially from the day with the smallest total number of jobs. Regarding the target day to search for a time period with long idle time, it is determined whether a time period of 3 consecutive hrs without a job is present (step S404). A time period of 3 consecutive hrs without a job is indicated with an ellipse of solid line in FIG. 6.

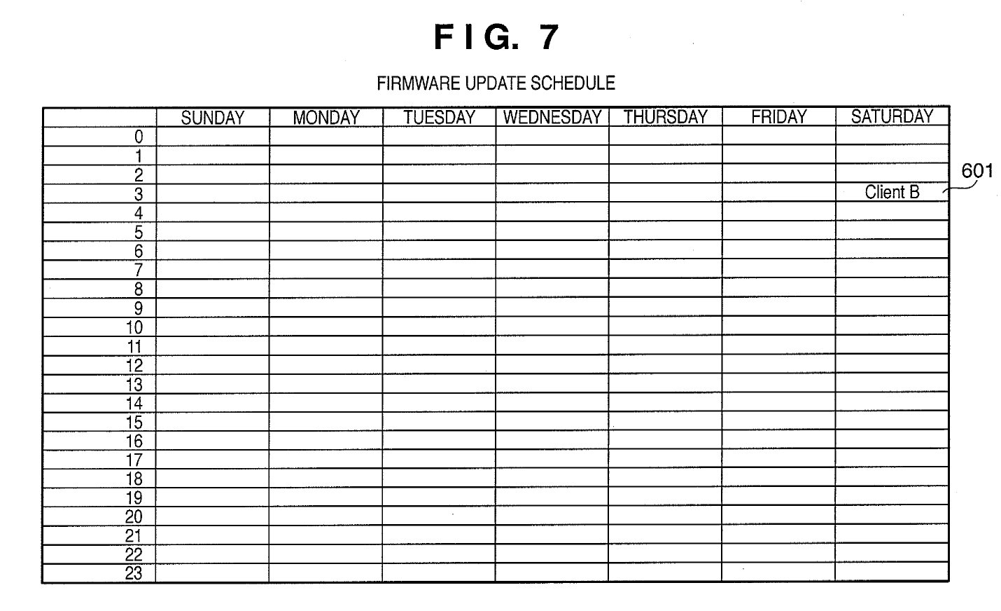

If it is determined in step S404 that a time period of 3 consecutive hrs without a job is present, the middle time is determined as a firmware update time, and the day and time of firmware update are registered (step S406). More specifically, “3:00” of a time period 501 in FIG. 6 is set as the firmware update time. The apparatus name (Client B) is registered at “3:00” (601 in FIG. 7) of Saturday in the schedule. FIG. 7 shows an example of a schedule managed by the server 201. In the schedule shown in FIG. 7, “X” indicates a time period from “X:00” to “X:59”. If there are a plurality of time periods of 3 consecutive hrs without a job, a time period with the minimum total number of jobs, including job counts in two preceding and succeeding hours, is selected, and its middle time is selected (when the job counts in the respective hours are represented by m, 0, 0, 0, and n, the total number of jobs is (m+n)).

In making schedules of a plurality of apparatuses, it is determined whether an apparatus without firmware update scheduling remains (step S414). If it is determined that an apparatus without firmware update scheduling remains, the process returns to step S403. If all apparatuses have finished firmware update scheduling, the process is ended.

If it is determined in step S404 that no time period of 3 consecutive hrs without job is present, it is determined whether any one of the days has not yet undergone the search of a time period of 3 consecutive hrs without job (step S405). If it is determined that a day has not yet undergone the search of a time period of 3 consecutive hrs without job, the process returns to step S404 to search for a time period of 3 consecutive hrs without job in the next day. If all days have undergone the search of a time period of 3 consecutive hrs without job, the process advances to step S407.

In step S407, sequentially from the day with the smallest total number of jobs, it is determined whether a time period of 2 consecutive hrs without job is present. A time period of 2 consecutive hrs without job is indicated by an ellipse of dotted line in FIG. 6.

If it is determined in step S407 that a time period of 2 consecutive hrs without job is present, one of the two times is determined as a firmware update time, and the day and time of firmware update are registered (step S409). The process advances to step 5414. More specifically, “6:00” of a time period 502 in FIG. 6 is set as the firmware update time. The apparatus name is registered at “6:00” of Saturday in the schedule. If there are a plurality of time periods of 2 consecutive hrs without job, a time period with the minimum total number of jobs, including job counts in two preceding and succeeding hours, is selected, and one of the times of the time period is selected (when the job counts in the respective hours are represented by m, 0, 0, and n, the total number of jobs is (m+n)). For example, if m>n, a time closer to n is determined as the firmware update time. If m≦n, a time closer to m is determined as the firmware update time. In this embodiment, a single time period can have schedules of two or more apparatuses.

If it is determined in step S407 that no time period of 2 consecutive hrs without job is present, it is determined whether any one of the days has not yet undergone the search of a time period of 2 consecutive hrs without job (step S408). If it is determined that a day has not yet undergone the search of a time period of 2 consecutive hrs without job, the process returns to step S407 to search for a time period of 2 consecutive hrs without job in the next day. If all days have undergone the search of a time period of 2 consecutive hrs without job, the process advances to step S410.

In step S410, sequentially from the day with the smallest total number of jobs, it is determined whether a time of 1 hr without job is present. A time of 1 hr without job is indicated by an ellipse of alternate long and short dashed line in FIG. 6.

If it is determined in step S410 that a time of 1 hr without job is present, that time is determined as a firmware update time, and the day and time of firmware update are registered (step S412). More specifically, “22:00” of a time period 503 in FIG. 6 is set as the firmware update time. The apparatus name is registered at “22:00” of Saturday in the schedule. If there are a plurality of times of 1 hr without job, a time period with the minimum total number of jobs, including job counts in two preceding and succeeding hours, is selected (when the job counts in the respective hours are represented by m, 0, and n, the total number of jobs is (m+n)). In this embodiment, a single time period can have schedules of two or more apparatuses.

If it is determined in step S410 that no time of 1 hr without job is present, it is determined whether any one of the days has not yet undergone the search of a time of 1 hr without job (step S411). If it is determined that a day has not yet undergone the search of a time of 1 hr without job, the process returns to step S410 to search for a time of 1 hr without job in the next day. If all days have undergone the search of a time of 1 hr without job, the process advances to step S413.

In step S413, the time with the minimum number of jobs in the day with the minimum total number of jobs is determined as the firmware update time, and the day and time of firmware update are registered. Let X be the minimum number of jobs. If there are a plurality of times with the number X of jobs, a time with the minimum total number of jobs, including job counts in two preceding and succeeding hours, is selected (when the job counts in the respective hours are represented by m, X, and n, the total number of jobs is (m+n)).

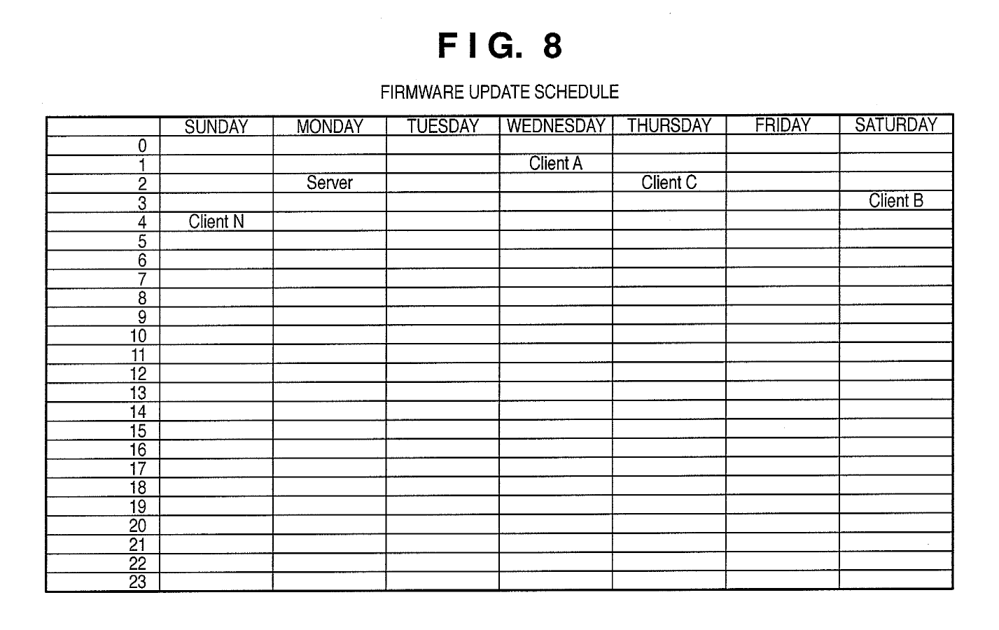

When the scheduling process shown in FIGS. 4 and 5 is executed, a firmware update schedule is determined for each of the plurality of image processing apparatuses, as shown in FIG. 8. In this embodiment, a single time period can have schedules of two or more apparatuses. However, it is necessary to set only the firmware update schedule of the server 201 in a time period different from those of the schedules of the clients 202 to 204.

According to the process shown in FIGS. 4 and 5, the time period with a low user's use frequency is determined as the firmware update time. It is therefore possible to reduce impediment to user's operations in executing program update in a data processing apparatus.

A process of updating firmware in the server 201 and clients 202 to 204 on the basis of the firmware update schedule shown in FIG. 8 will be described next.

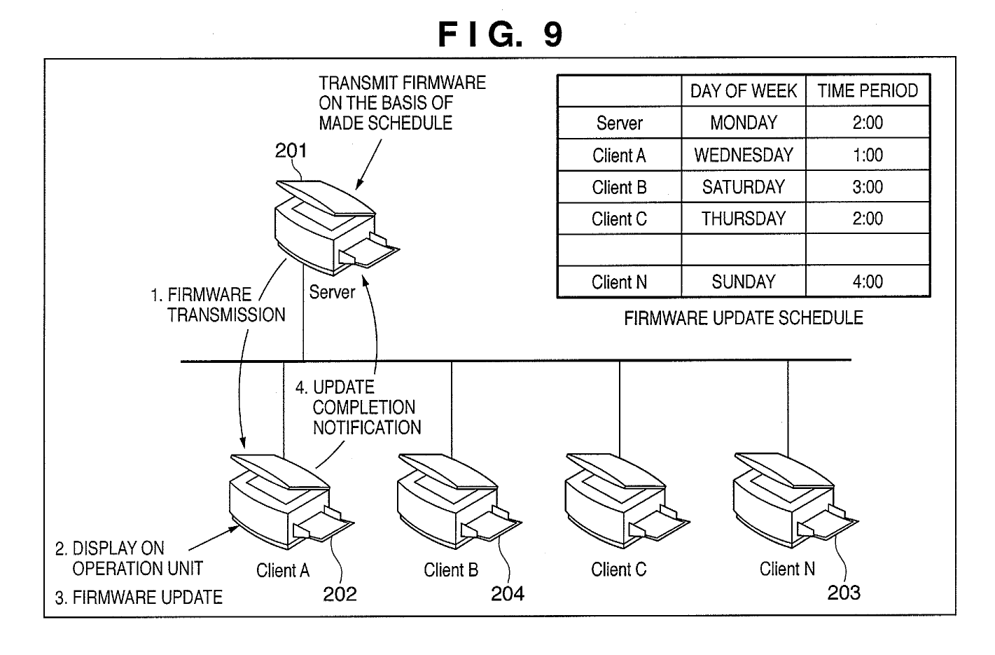

FIG. 9 is a view for explaining a firmware update process executed by the server 201 and clients 202 to 204 in FIG. 3.

Referring to FIG. 9, the server 201 manages the schedule shown in FIG. 8. The server 201 transmits update firmware data necessary for firmware update to each of the clients 202 to 204 as a firmware update target. The update firmware data contains not only new firmware but also commands for controlling firmware update. Each of the clients 202 to 204 finishes firmware update and notifies the server 201 of it. When the firmware update target is the server 201, the server 201 updates firmware by itself on the basis of update firmware data.

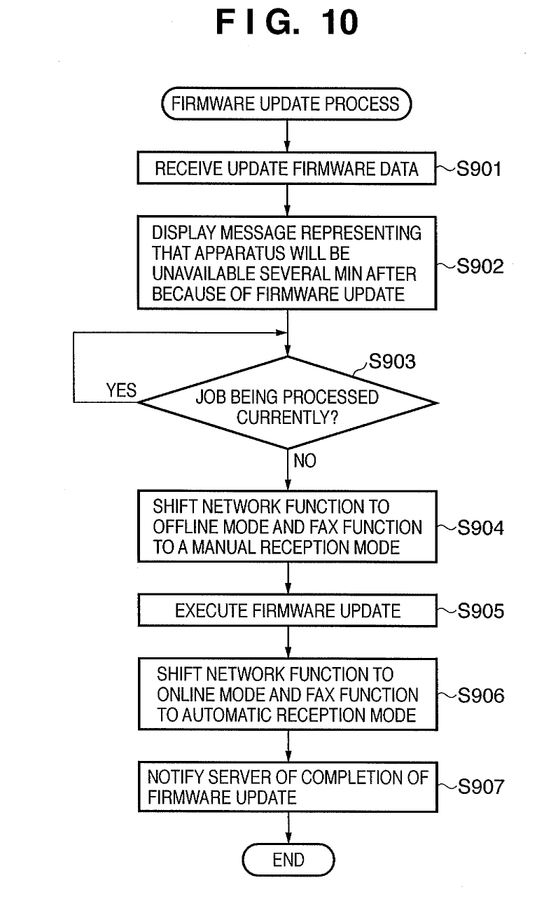

FIG. 10 is a flowchart illustrating the firmware update process executed by each of the clients 202 to 204. This firmware update process is done by causing the CPU 101 of each of the clients 202 to 204 to execute a program based on the flowchart in FIG. 10. In the following description, assume that the client 202 executes the firmware update process.

At 1:00 on Wednesday, the server 201 transmits update firmware data to the client 202 as the firmware update target in accordance with the schedule shown in FIG. 8. The client 202 receives the update firmware data from the server 201 (step S901).

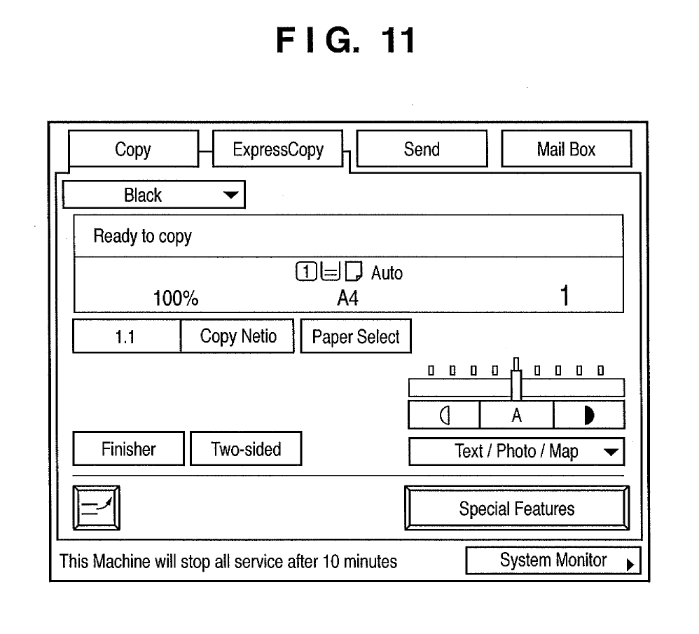

Upon receiving the update firmware data, the client 202 displays, on the display unit 105, a message representing that the apparatus will be unavailable several min after because of firmware update, as shown in FIG. 11 (step S902). If a user tries to use the client 202, he/she is promoted to use another image processing apparatus.

The client 202 determines whether a job is currently being processed (step S903). If it is determined that a job is currently being processed, the client 202 waits until the job is ended. If no job is being processed, the client 202 shifts the network function to an offline mode to inhibit new job reception and also shifts the FAX function to a manual reception mode to neglect FAX reception (step S904). The client 202 is thus set in a state to inhibit new job reception.

The client 202 executes firmware update (step S905). When firmware update is normally ended, the client 202 shifts the network function to an online mode and the FAX function to an automatic reception mode to enable FAX reception (step S906). The client 202 is thus set in a state to receive a new job.

The client 202 notifies the server 201 that firmware update is normally ended (step S907), and the process is ended. Upon receiving the notification, the server 201 records the completion of firmware update in the schedule (e.g., FIG. 8) managed by it. When the server 201 is the firmware update target, the server 201 executes steps S902 to S906 and then records the completion of firmware update in the schedule (e.g., FIG. 8).

According to the process in FIG. 10, firmware update is done in a time period with a low user's use frequency. It is therefore possible to reduce impediment to user's operations in executing program update in a data processing apparatus.

### Second Embodiment

In the first embodiment, a plurality of image processing apparatuses can execute firmware update in the same time period. In the second embodiment, to prevent a plurality of image processing apparatuses from becoming unavailable simultaneously during firmware update, the plurality of image processing apparatuses are inhibited from executing firmware update in the same time period.

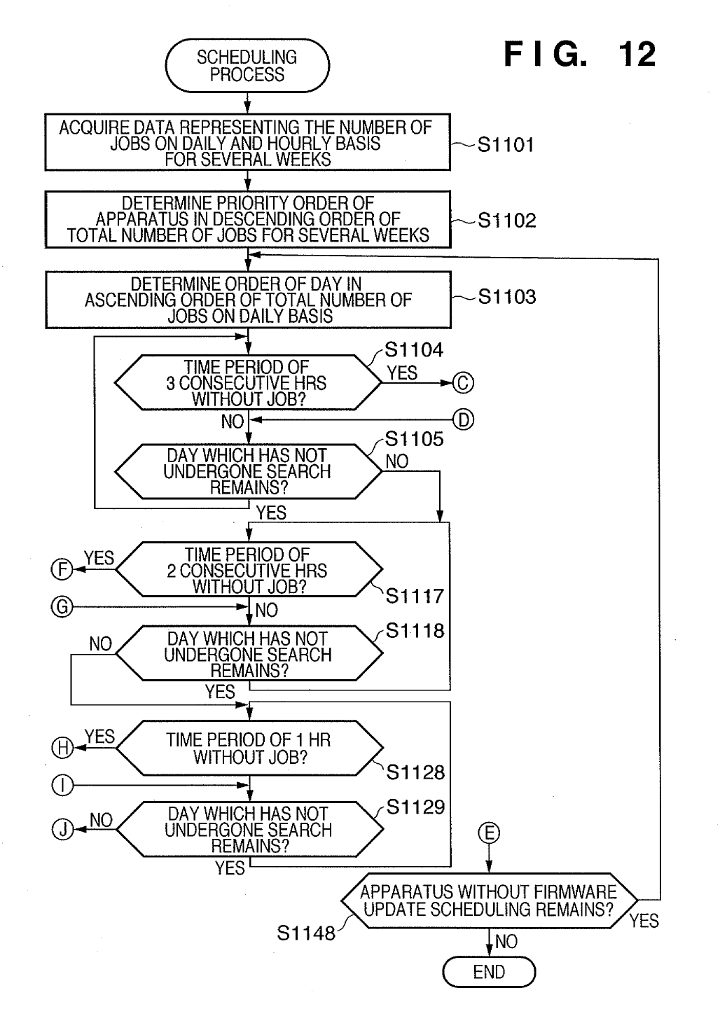

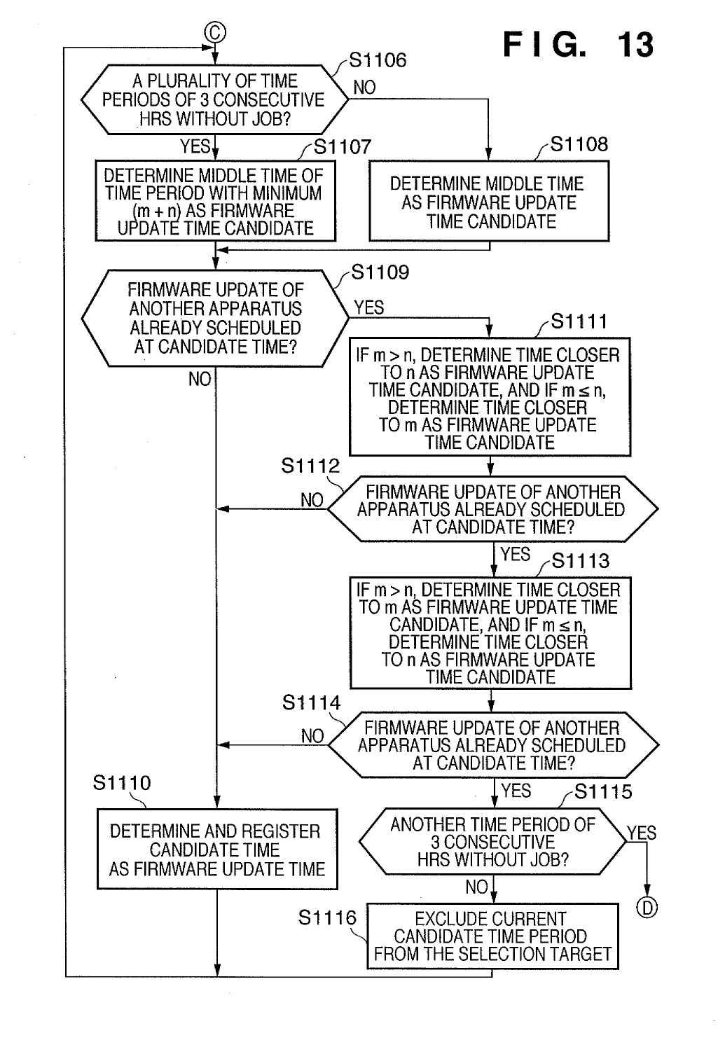

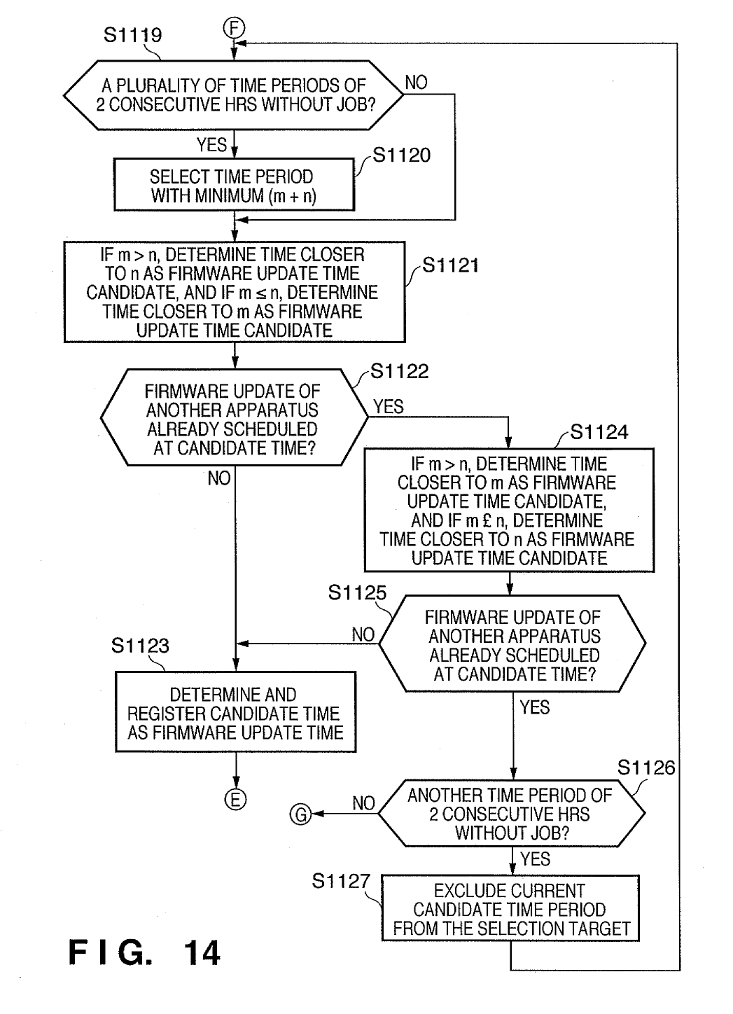

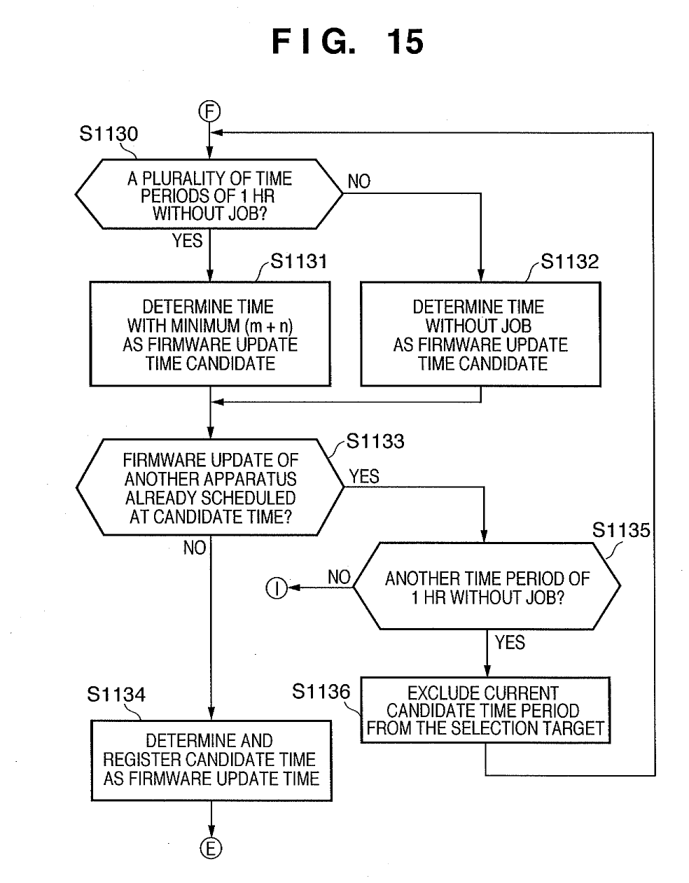

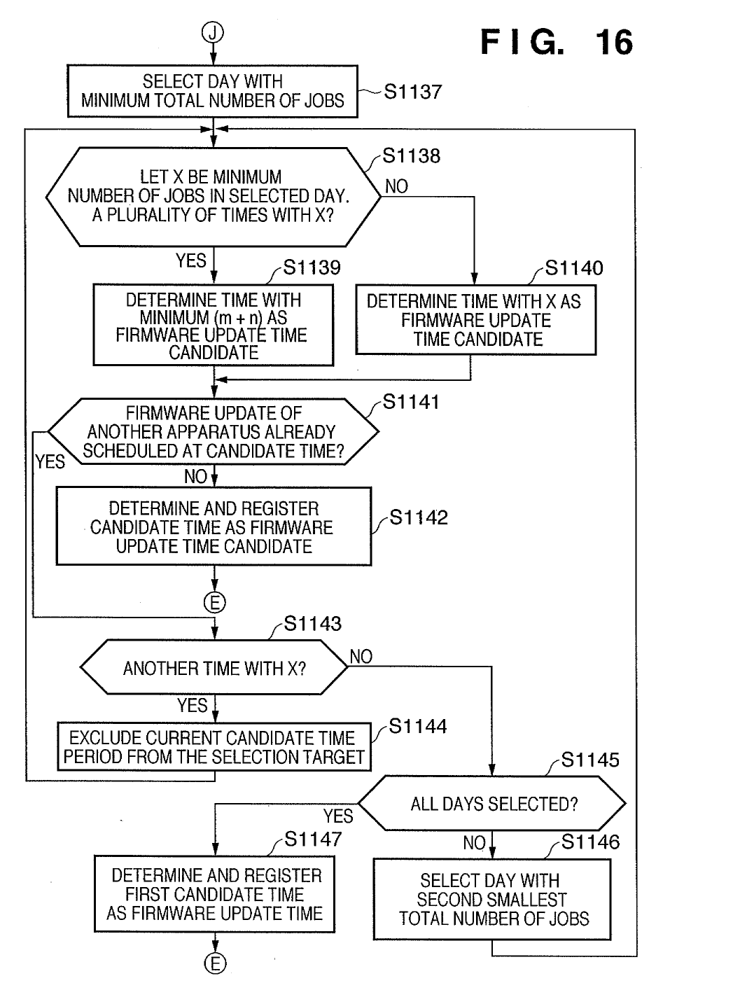

FIGS. 12 to 16 are flowcharts illustrating a firmware update scheduling process according to the second embodiment. This scheduling process is done by causing a CPU 101 of a server 201 to execute a program based on the flowcharts in FIGS. 12 to 16.

Referring to FIG. 12, the server 201 acquires data representing the number of jobs on the daily and hourly basis for several weeks held by itself and by clients 202 to 204 (step S1101). The server 201 calculates the total number of jobs in each apparatus for several weeks and determines the priority order of firmware update in descending order of the total number of jobs for several weeks (step S1102). FIG. 3 shows an example of the determined priority order. An apparatus with a large total number of jobs for several weeks is frequently used by users. Such an apparatus is supposed to have little idle time without job execution. Hence, firmware update scheduling is performed preferentially for the apparatus with the large total number of jobs for several weeks.

Next, firmware update scheduling is done sequentially from the apparatus with the largest total number of jobs for several weeks (i.e., the apparatus with the highest priority order of firmware update). First, for the scheduling target apparatus, the total number of jobs on the daily basis is calculated from the acquired data representing the number of jobs on the daily and hourly basis for several weeks, as shown in FIG. 6. An order is determined in ascending order of the total number of jobs on the daily basis (step S1103). This is because a day with a small total number of jobs can ensure long idle time at a high probability. In FIG. 6, Saturday with the smallest total number of jobs is given order “1”.

After the calculation in step S1103, a time period with long idle time is searched for sequentially from the day with the smallest total number of jobs. Regarding the target day to search for a time period with long idle time, it is determined whether a time period of 3 consecutive hrs without job is present (step S1104).

If it is determined in step S1104 that a time period of 3 consecutive hrs without job is present, it is determined whether there are a plurality of time periods each of 3 consecutive hrs without job (step S1106). If it is determined that there are a plurality of time periods of 3 consecutive hrs without job, the process advances to step S1107. In step S1107, a time period with the minimum total number of jobs, including job counts in two hours before and after the time period of 3 consecutive hrs without job, is selected as a firmware update time period candidate (when the job counts in the respective hours are represented by m, 0, 0, 0, and n, the total number of jobs is (m+n)). Then, the middle time of the time period is selected as a firmware update time candidate, and the process advances to step S1109.

If it is determined in step S1106 that there are not a plurality of time periods of 3 consecutive hrs. without job, the only time period of 3 consecutive hrs without job is selected as a firmware update time period candidate. Then, the middle time of the time period is selected as a firmware update time candidate (step S1108), and the process advances to step S1109.

In step S1109, the schedule is compared with the candidate time to determine whether firmware update of another apparatus is already scheduled at the candidate time. If it is determined that firmware update of another apparatus is not yet scheduled at the candidate time, the candidate time is determined as the firmware update time, and the apparatus name is registered at a corresponding time of the schedule (step S1110).

If it is determined in step S1109 that firmware update of another apparatus is already scheduled at the candidate time, the process advances to step S1111. In step S1111, if m>n, a time closer to n is determined as the firmware update time candidate. If m≦n, a time closer to m is determined as the firmware update time candidate.

Next, the schedule is compared with the candidate time to determine whether firmware update of another apparatus is already scheduled at the candidate time (step S1112). If it is determined that firmware update of another apparatus is not yet scheduled at the candidate time, the candidate time is determined as the firmware update time, and the apparatus name is registered at a corresponding time of the schedule (step S1110).

If it is determined in step S1112 that firmware update of another apparatus is already scheduled at the candidate time, the process advances to step S1113. In step S1113, if m>n, a time closer to m is determined as the firmware update time candidate. If m≦n, a time closer to n is determined as the firmware update time candidate.

Next, the schedule is compared with the candidate time to determine whether firmware update of another apparatus is already scheduled at the candidate time (step S1114). If it is determined that firmware update of another apparatus is not yet scheduled at the candidate time, the candidate time is determined as the firmware update time, and the apparatus name is registered at a corresponding time of the schedule (step S1110).

If it is determined in step S1114 that firmware update of another apparatus is already scheduled at the candidate time, it is determined whether another time period of 3 consecutive hrs without job is present (step S1115).

If it is determined in step S1115 that another time period of 3 consecutive hrs without job is present, the current candidate time period is excluded from the selection targets (step S1116), and the process returns to step S1106.

If it is determined in step S1115 that no other time period of 3 consecutive hrs without job is present, it is determined whether any one of the days has not yet undergone the search of a time period of 3 consecutive hrs without job (step S1105). If it is determined that a day has not yet undergone the search of a time period of 3 consecutive hrs without job, the process returns to step S1104. If all days have undergone the search of a time period of 3 consecutive hrs without job, the process advances to step S1117. In step S1117, sequentially from the day with the smallest total number of jobs, it is determined whether a time period of 2 consecutive hrs without job is present.

If it is determined in step S1117 that a time period of 2 consecutive hrs without job is present, it is determined whether there are a plurality of time periods each of 2 consecutive hrs without job (step S1119). If it is determined that there are not a plurality of time periods of 2 consecutive hrs without job, the only time period of 2 consecutive hrs without job is selected as a firmware update time period candidate, and the process advances to step S1121. If it is determined that there are a plurality of time periods of 2 consecutive hrs without job, the process advances to step S1120. In step S1120, a time period with the minimum total number of jobs, including job counts in two hours before and after the time period of 2 consecutive hrs without job, is selected as a firmware update time period candidate (when the job counts in the respective hours are represented by m, 0, 0, and n, the total number of jobs is (m+n)).

In step S1121, if m>n, a time closer to n is determined as the firmware update time candidate. If m≦n, a time closer to m is determined as the firmware update time candidate (step S1121).

Next, the schedule is compared with the candidate time to determine whether firmware update of another apparatus is already scheduled at the candidate time (step S1122). If it is determined that firmware update of another apparatus is not yet scheduled at the candidate time, the candidate time is determined as the firmware update time, and the apparatus name is registered at a corresponding time of the schedule (step S1123).

If it is determined in step S1122 that firmware update of another apparatus is already scheduled at the candidate time, the process advances to step S1124. In step S1124, if m>n, a time closer to m is determined as the firmware update time candidate. If m≦n, a time closer to n is determined as the firmware update time candidate.

Next, the schedule is compared with the candidate time to determine whether firmware update of another apparatus is already scheduled at the candidate time (step S1125). If it is determined that firmware update of another apparatus is not yet scheduled at the candidate time, the candidate time is determined as the firmware update time, and the apparatus name is registered at a corresponding time of the schedule (step S1123).

If it is determined in step S1125 that firmware update of another apparatus is already scheduled at the candidate time, it is determined whether another time period of 2 consecutive hrs without job is present (step S1126).

If it is determined in step S1126 that another time period of 2 consecutive hrs without job is present, the current candidate time period is excluded from the selection targets (step S1127), and the process returns to step S1119.

If it is determined in step S1126 that no other time period of 2 consecutive hrs without job is present, it is determined whether any one of the days has not yet undergone the search of a time period of 2 consecutive hrs without job (step S1118). If it is determined that a day has not yet undergone the search of a time period of 2 consecutive hrs without job, the process returns to step S1117. If all days have undergone the search of a time period of 2 consecutive hrs without job, the process advances to step S1128. In step S1128, sequentially from the day with the smallest total number of jobs, it is determined whether a time of 1 hr without job is present.

If it is determined in step S1128 that a time of 1 hr without job is present, it is determined whether there are a plurality of times of 1 hr without job (step S1130). If it is determined that there are a plurality of times of 1 hr without job, the process advances to step S1131. In step S1131, a time period with the minimum total number of jobs, including job counts in two hours before and after the time of 1 hr without job, is selected as a firmware update time candidate (when the job counts in the respective hours are represented by m, 0, and n, the total number of jobs is (m+n)). The process advances to step S1133.

If it is determined in step S1130 that there are not a plurality of times of 1 hr without job, the only time of 1 hr without job is selected as a firmware update time candidate (step S1132), and the process advances to step S1133.

Next, the schedule is compared with the candidate time to determine whether firmware update of another apparatus is already scheduled at the candidate time (step S1133). If it is determined that firmware update of another apparatus is not yet scheduled at the candidate time, the candidate time is determined as the firmware update time, and the apparatus name is registered at a corresponding time of the schedule (step S1134).

If it is determined in step S1133 that firmware update of another apparatus is already scheduled at the candidate time, it is determined whether another time of 1 hr without job is present (step S1135).

If it is determined in step S1135 that another time of 1 hr without job is present, the current candidate time is excluded from the selection targets (step S1136), and the process returns to step S1130.

If it is determined in step S1135 that no other time of 1 hr without job is present, it is determined whether any one of the days has not yet undergone the search of a time of 1 hr without job (step S1129). If it is determined that a day has not yet undergone the search of a time of 1 hr without job, the process returns to step S1128. If all days have undergone the search of a time of 1 hr without job, the day with the minimum total number of jobs is selected (step S1137).

Let X be the minimum number of jobs in the selected day. It is determined whether there are a plurality of times with the number X of jobs (step S1138).

If it is determined that there are a plurality of times with the number X of jobs, the process advances to step S1139. In step S1139, a time with the minimum total number of jobs, including job counts in two hours before and after the time with the number X of jobs, is selected as a firmware update time candidate (when the job counts in the respective hours are represented by m, X, and n, the total number of jobs is (m+n)). Then, the process advances to step S1141.

If it is determined in step S1138 that there are not a plurality of times with the number X of jobs, the only time with the number X of jobs is selected as a firmware update time candidate (step S1140), and the process advances to step S1141.

Next, the schedule is compared with the candidate time to determine whether firmware update of another apparatus is already scheduled at the candidate time (step S1141). If it is determined that firmware update of another apparatus is not yet scheduled at the candidate time, the candidate time is determined as the firmware update time, and the apparatus name is registered at a corresponding time of the schedule (step S1142).

If it is determined in step S1141 that firmware update of another apparatus is already scheduled at the candidate time, it is determined whether another time with the number X of jobs is present (step S1143).

If it is determined in step S1143 that another time with the number X of jobs is present, the current candidate time is excluded from the selection targets (step S1144), and the process returns to step S1138.

If it is determined in step S1143 that no other time with the number X of jobs is present, it is determined whether all days are selected in step S1137 or S1146 (step S1145). If it is determined that not all days are selected, the day with the second smallest total number of jobs is selected (step S1146), and the process returns to step S1138.

If all days are selected, the process advances to step S1147. In step S1147, the first candidate time is determined as the firmware update time, the apparatus name is registered at a corresponding time of the schedule, and the process advances to step S1148. In this case, the firmware update time coincides with that of another apparatus.

In step S1148, it is determined whether any one of the apparatuses has not yet undergone firmware update scheduling. If it is determined that an apparatus has not yet undergone firmware update scheduling, the process returns to step S1103. If all apparatuses have finished firmware update scheduling, the process is ended.

When the scheduling process shown in FIGS. 12 to 16 is executed, a firmware update schedule is determined for each of the plurality of image processing apparatuses, as shown in FIG. 8.

It is necessary to set only the firmware update schedule of the server 201 in a time period different from those of the schedules of the clients 202 to 204.

According to the process shown in FIGS. 12 to 16, firmware update of an apparatus is scheduled in a time period without coincidence with that of another apparatus. It is therefore possible to prevent a plurality of image processing apparatuses from becoming unavailable simultaneously during firmware update.

### Third Embodiment

In the first and second embodiments, if a job is being processed at the time of firmware update, firmware update is executed after the end of the job. In the third embodiment, if a job is being processed at the time of firmware update, a firmware update rescheduling request is sent to the server.

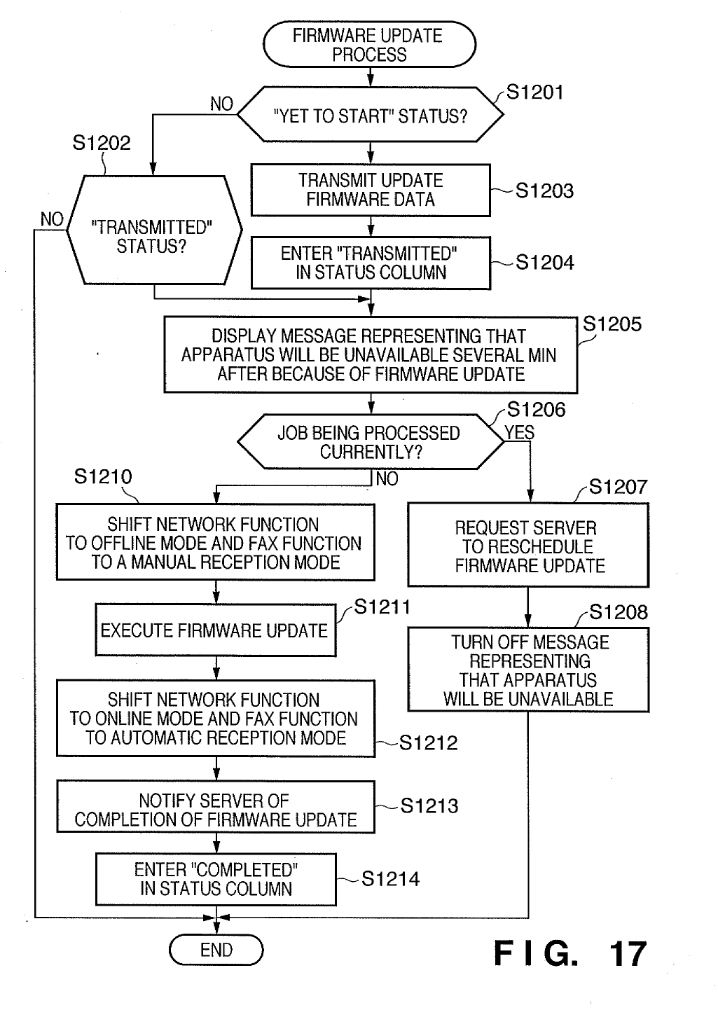

FIG. 17 is a flowchart illustrating a firmware update process according to the third embodiment. In the following description, assume that a client 202 is the firmware update target.

Referring to FIG. 17, when the time of firmware update has come, a server 201 determines whether the status of the client 202 as the firmware update target is “yet to start” (step S1201).

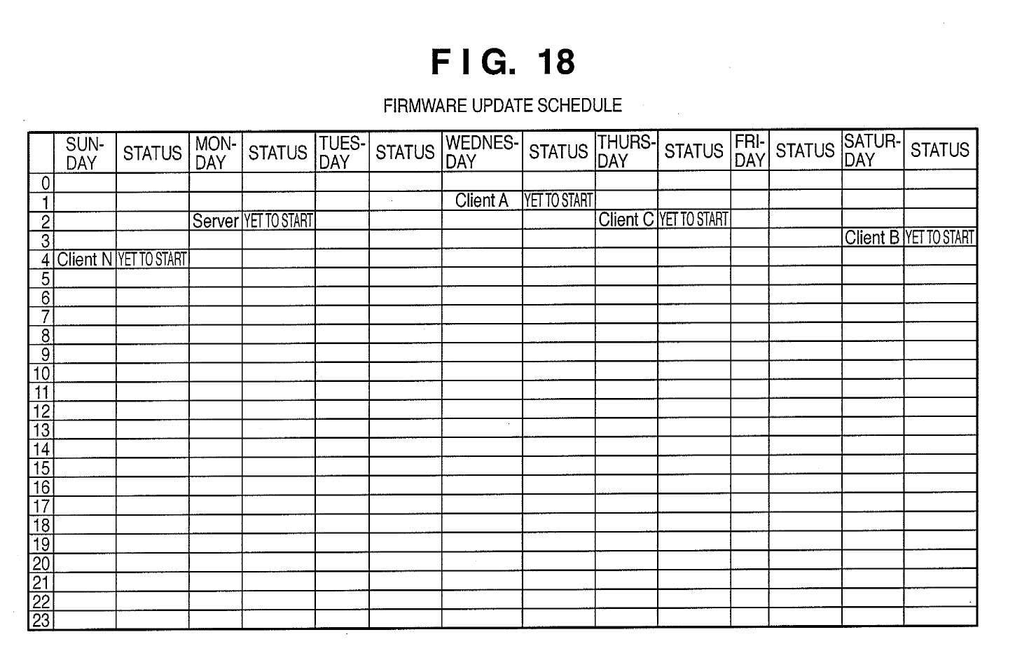

The schedule shown in FIG. 18 has status columns to know the firmware update states of the server 201 and the clients 202 to 204.

In making a firmware update schedule by the scheduling process shown in FIGS. 4 and 5 or FIGS. 12 to 16, neither transmission nor update of firmware is done yet. Hence, “yet to start” is entered in the status column of each apparatus.

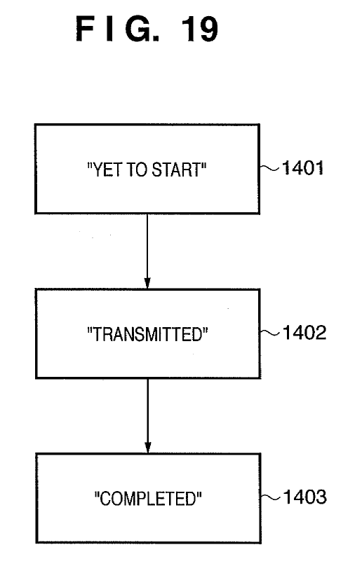

As shown in FIG. 19, a “yet to start” status 1401 indicates that neither transmission nor update of firmware is done yet.

A “transmitted” status 1402 indicates that update firmware data is already transmitted to an apparatus.

A “completed” status 1403 indicates that update firmware data transmission to an apparatus is ended, and firmware update is also normally ended.

If it is determined in step S1201 that the status of the client 202 is “yet to start”, the process advances to step S1203. If the status of the client 202 is not “yet to start”, the server 201 determines whether the status of the client 202 is “transmitted” (step S1202).

If it is determined in step S1202 that the status of the client 202 is “transmitted”, the process advances to step S1205. If the status of the client 202 is not “transmitted”, the status is “completed”. Hence, the process is ended.

In step S1203, the server 201 transmits update firmware data to the client 202. When the transmission finishes, the server 201 enters “transmitted” in the status column corresponding to the client 202 in the schedule shown in FIG. 18 (step S1204).

Upon receiving the update firmware data, the client 202 displays, on a display unit 105, a message representing that the apparatus will be unavailable several min after because of firmware update, as shown in FIG. 11 (step S1205). This notifies the user that the firmware update operation will automatically start.

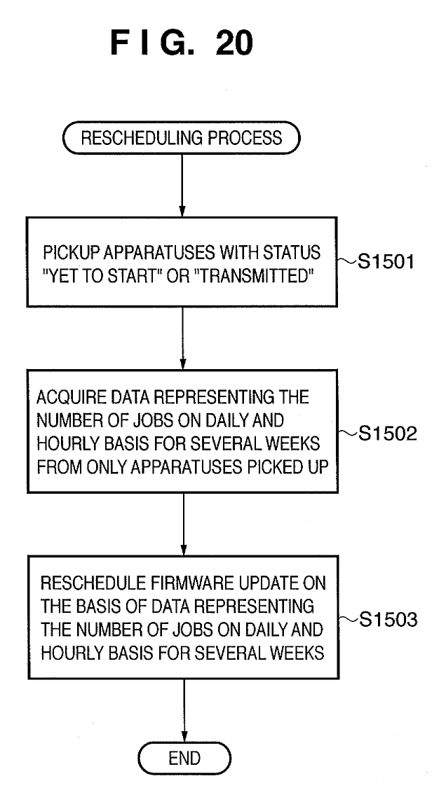

The client 202 determines whether a job is currently being processed (step S1206). If it is determined that a job is currently being processed, the client 202 requests the server 201 to reschedule firmware update (step S1207). This notification can be sent to the server 201 by any method such as mail or communication with handshaking accompanied by Socket communication. The server 201 executes a rescheduling process (to be described later) in FIG. 20 to reschedule firmware update.

The client 202 turns off the message displayed in step S1205 to notify the user that the apparatus will be unavailable because of firmware update (step S1208).

If it is determined in step S1206 that no job is being processed, the process advances to step S1210. In step S1210, the client 202 shifts the network function to an offline mode to inhibit new job reception and also shifts the FAX function to a manual reception mode to neglect FAX reception. The client 202 is thus set in a state to inhibit new job reception.

The client 202 executes firmware update (step S1211). When firmware update is normally ended, the client 202 shifts the network function to an online mode and the FAX function to an automatic reception mode to enable FAX reception (step S1212). The client 202 is thus set in a state to receive a new job.

The client 202 notifies the server 201 that firmware update is normally ended (step S1213). Upon receiving the notification, the server 201 enters “completed” in the status column corresponding to the client 202 in the schedule managed by itself (step S1214), and the process is ended.

According to the process in FIG. 19, if a job process is progressing when firmware update is going to start, a firmware update rescheduling request is sent to the server. It is therefore possible to reduce impediment to user's operations in executing program update in a data processing apparatus. If the server 201 is the firmware update target, it executes steps S1201 and S1202, S1204 to S1208, S1210 to S1212 and S1214.

FIG. 20 is a flowchart illustrating the rescheduling process executed by the server 201. This rescheduling process is done by causing a CPU 101 of the server 201 to execute a program based on the flowchart in FIG. 20. In this case as well, assume that a client 202 is the firmware update target.

Referring to FIG. 20, upon receiving a rescheduling request from the client 202, the server 201 picks up only apparatuses with status “yet to start” or “transmitted” on the basis of the schedule in FIG. 18 (step S1501). An apparatus with status “completed” has already finished firmware update and is therefore not subjected to rescheduling.

The server 201 reacquires data representing the number of jobs on the daily and hourly basis for several weeks held by the apparatuses picked up in step S1501 (step S1502).

On the basis of the acquired data representing the number of jobs on the daily and hourly basis for several weeks, the server 201 executes the scheduling process shown in FIGS. 4 and 5 or FIGS. 12 to 16, thereby rescheduling firmware update (step S1503), and the process is ended. That is, the server remakes the schedule on the basis of the latest state.

According to the process shown in FIG. 20, if a job process is progressing when firmware update is going to start, firmware update rescheduling is automatically executed. It is therefore possible to reduce impediment to user's operations in executing program update in a data processing apparatus.

### Fourth Embodiment

In the first to third embodiments, the firmware update schedule is made on the basis of a time period with a low user's use frequency. For this reason, at the time of firmware update, an image processing apparatus that is not used for a long time has been shifted to a low-power sleep state at a high probability. Even the server 201 has been set in the low-power sleep state at a high probability, if it is not used for a long time. In the fourth embodiment, a server 201 or clients 202 to 204 execute a wakeup process from the sleep state.

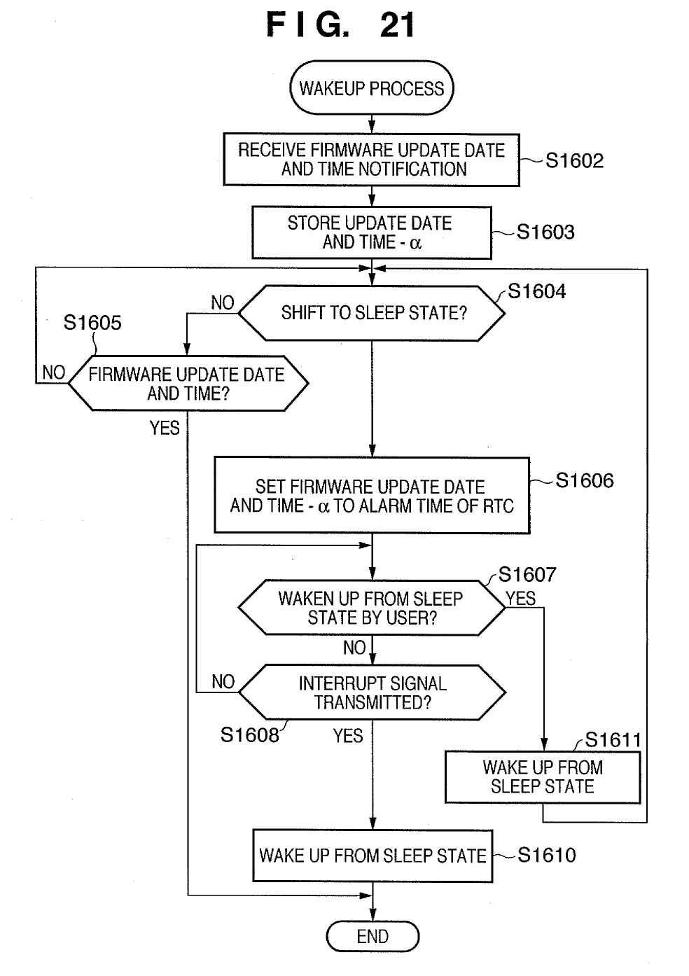

FIG. 21 is a flowchart illustrating the wakeup process of the clients 202 to 204. This wakeup process is done by causing a CPU 101 of each of the clients 202 to 204 to execute a program based on the flowchart in FIG. 21.

When the schedule in FIG. 8 or 18 is made, the server 201 notifies a client as a firmware update target of the firmware update date and time based on the schedule in FIG. 8 or 18. Hence, the client receives the firmware update date and time notification from the server 201 (step S1602). This notification can be sent from the server 201 by any method such as mail or data notification by Socket communication using a specified Port.

Upon receiving the firmware update date and time notification from the server 201, the client stores “firmware update date and time −α” in, e.g., a RAM 103 (step S1603). The “−α” is necessary because it is assumed that a client in a sleep state takes time for wakeup.

In step S1604, the client determines whether to shift to the sleep state. More specifically, each client is set to shift to the low-power sleep state if neither user process nor job reception is done for a predetermined time. Each client can set the predetermined time. Hence, the client determines whether it is left unused for the predetermined time.

If it is determined that the client does not shift to the sleep state, it is determined whether the firmware update date and time have come (step S1605). If it is determined that the firmware update date and time have not come yet, the process returns to step S1604. If the firmware update date and time have come, the process is ended. When the process is ended, the firmware update process is executed.

If it is determined in step S1604 to shift to the sleep state, the client sets the “firmware update date and time −α” stored in the RAM 103 in step S1603 to the alarm time of an RTC 114 and shifts to the sleep state (step S1606).

Next, the client determines whether the user wakes up it from the sleep state (step S1607). If it is determined that the user wakes up the client from the sleep state, the client wakes up from the sleep state (step S1611), and the process returns to step S1604.

If it is determined in step S1607 that the user does not wake up the client from the sleep state, the client determines whether the RTC 114 has generated an interrupt signal (step S1608). When the alarm time has come, the RTC 114 transmits an interrupt signal by hardware.

When the interrupt signal is transmitted from the RTC 114, a Reset cancel signal is transmitted to the CPU 101. The client wakes up from the sleep state (step S1610), and the process is ended. When the process is ended, the firmware update process is executed.

According to the process in FIG. 21, even if the clients 202 to 204 are in the sleep state when firmware update is going to start, the firmware update process can be executed.

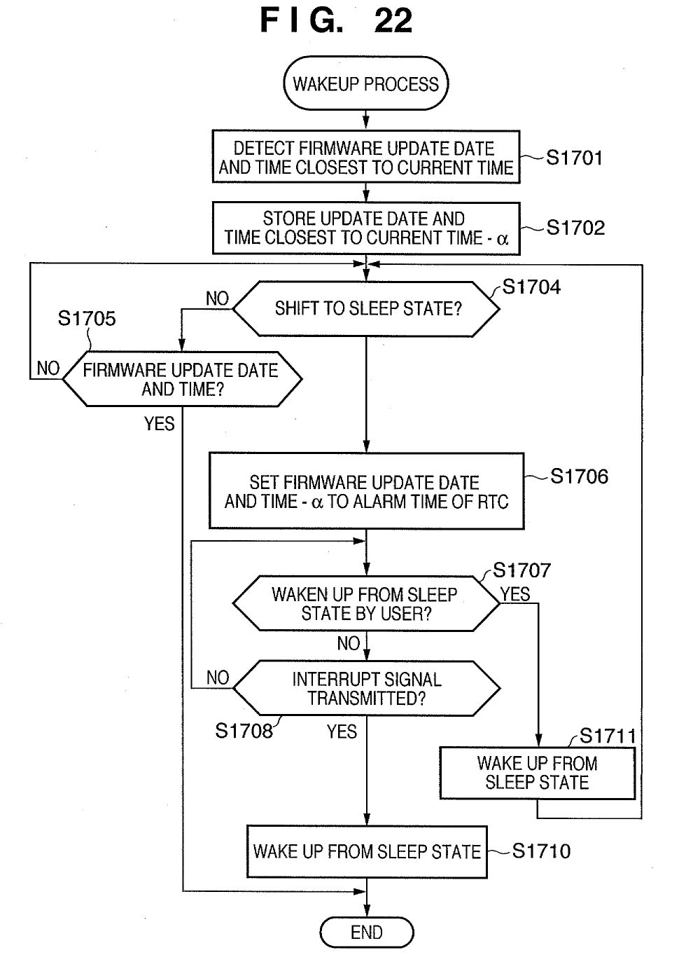

FIG. 22 is a flowchart illustrating the wakeup process of the server 201. This wakeup process is done by causing the CPU 101 of the server 201 to execute a program based on the flowchart in FIG. 22.

When the schedule in FIG. 8 or 18 is made, the server 201 detects the firmware update date and time closest to the current time based on the schedule in FIG. 8 or 18 (step S1701). The server 201 stores, in, e.g., the RAM 103, “firmware update date and time closest to current time −α” detected in step S1701 (step S1702). The “−α” is necessary because it is assumed that the server 201 in a sleep state takes time for wakeup.

In step S1704, the server 201 determines whether to shift to the sleep state. More specifically, the server 201 is set to shift to the low-power sleep state if neither user process nor job reception is done for a predetermined time. The server 201 can set the predetermined time. Hence, the server 201 determines whether it is left unused for the predetermined time.

If it is determined that the server 201 does not shift to the sleep state, it is determined whether the firmware update date and time detected in step S1701 have come (step S1705). If it is determined that the firmware update date and time detected in step S1701 have not come yet, the process returns to step S1704. If the firmware update date and time detected in step S1701 have come, the process is ended. When the process is ended, the firmware update process is executed.

If it is determined in step S1704 to shift to the sleep state, the server 201 sets the “firmware update date and time closest to current time −α” stored in the RAM 103 in step S1702 to the alarm time of the RTC 114 and shifts to the sleep state (step S1706).

Next, the server 201 determines whether the user wakes up it from the sleep state (step S1707). If it is determined that the user wakes up the server 201 from the sleep state, the server 201 wakes up from the sleep state (step S1711), and the process returns to step S1704.

If it is determined in step S1707 that the user does not wake up the server 201 from the sleep state, the server 201 determines whether the RTC 114 has generated an interrupt signal (step S1708). When the alarm time has come, the RTC 114 transmits an interrupt signal by hardware (step S1709).

When the interrupt signal is transmitted from the RTC 114, a Reset cancel signal is transmitted to the CPU 101. The server 201 wakes up from the sleep state (step S1710), and the process is ended. When the process is ended, the firmware update process is executed.

According to the process in FIG. 22, even if the server 201 is in the sleep state when firmware update is going to start, the firmware update process can be executed.

In the above embodiments, the server 201 acquires data representing the number of jobs executed in every specific time from the clients 202 to 204, determines the firmware transmission schedule based on the acquired data, and transmits firmware to the clients 202 to 204 in accordance with the determined schedule. However, any other form may be used.

More specifically, the server 201 transmits firmware to the clients 202 to 204 before the schedule determined by it. The server 201 transmits, to the clients 202 to 204, an instruction to update the firmware in accordance with the determined schedule. In this case, when the clients 202 to 204 receive the firmware update instruction, they have already received the firmware from the server 201. It is therefore possible to update the firmware by using the received firmware.

Still another form is also available. More specifically, the server 201 transmits firmware to the clients 202 to 204 before the schedule determined by it. Simultaneously with firmware transmission, the server 201 transmits, to the clients 202 to 204, information representing the timing when each client should update firmware in accordance with the schedule determined by the server 201. In this case, the clients 202 to 204 update the firmware on the basis of the information representing the timing when each client should update the firmware in accordance with the schedule determined by the server 201.

All the processes and functions described in the above embodiments can be implemented by, e.g., a computer-readable program.

In this case, the processes and functions described in the above embodiments are implemented by causing a computer (or CPU or MPU) included in a system or apparatus to execute the above programs. In other words, the above programs cause the computer included in the system or apparatus to execute the processes and functions described in the above embodiments. In this case, the programs are supplied to the computer included in the system or apparatus through a computer-readable storage medium or network.

As the storage medium to supply the programs to the computer included in the system or apparatus, a magnetic disk, optical disk, magnet-optical disk, hard disk, magnetic tape, nonvolatile memory, or the like can be used.

The above programs may partially be configured by using, e.g., an OS (Operating System) running on the computer.

The programs may be configured to be partially executed by a function expansion board inserted to the computer or a function expansion unit connected to the computer.

According to the present invention, a program update schedule for a data processing apparatus is determined on the basis a job execution situation in the data processing apparatus. It is therefore possible to reduce impediment to user's operations in executing program update in the data processing apparatus.

To prevent a plurality of data processing apparatuses from executing program update in the same time, program update of each of the plurality of data processing apparatuses is scheduled in a time with minimum job execution or a time without job execution. It is therefore possible to prevent the plurality of data processing apparatuses from becoming unavailable simultaneously during firmware update.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2006-339065, filed on Dec. 15, 2006, which is hereby incorporated by reference herein in its entirety.

What is claimed is:

1. A server apparatus for transmitting data necessary for program update to a client apparatus comprising:
an acquisition unit configured to acquire, from said client apparatus, job execution status representing the status of jobs executed in each of a plurality of periods of time by said client apparatus; and
a scheduling unit configured to determine a schedule of program update in said client apparatus on the basis of the job execution status acquired by said acquisition unit.

2. The apparatus according to claim 1, wherein said scheduling unit detects one of a period of time with minimum job execution and a period of time without job execution in said client apparatus on the basis of the job execution status acquired by said acquisition unit, and determines the schedule of program update on the basis of the detected time.

3. The apparatus according to claim 2, wherein
said acquisition unit acquires the job execution status from each of a plurality of client apparatuses, and
said scheduling unit determines the schedule of program update in each of the plurality of client apparatuses on the basis of the job execution status acquired from the plurality of client apparatuses by said acquisition unit not to make the plurality of client apparatuses execute program update in the same period of time.

4. The apparatus according to claim 1, further comprising a transmission unit configured to transmit data necessary for program update in said client apparatus in accordance with the schedule of program update determined by said scheduling unit.

5. A apparatus according to claim 1, wherein the job execution status representing the number of jobs executed in each of a plurality of periods of time by said client apparatus.

6. A data processing system having a client apparatus for executing a job and a server apparatus for transmitting data necessary for program update to said client apparatus,
said server apparatus comprising:
an acquisition unit configured to acquire, from said client apparatus, job execution status representing the status of jobs executed in each of a plurality of periods of time by said client apparatus;
a scheduling unit configured to determine a schedule of program update in said client apparatus on the basis of the job execution status acquired by said acquisition unit; and
a transmission unit configured to transmit data necessary for program update to said client apparatus in accordance with the schedule of program update determined by said scheduling unit, and
said client apparatus comprising:
a storage unit configured to store the job execution status;
a reception unit configured to receive the data necessary for program update from said server apparatus; and
an update unit configured to execute program update on the basis of the data received by said reception unit when no job is being executed.

7. The system according to claim 6, wherein said client apparatus further comprises a notification unit configured to notify said server apparatus of an end of program update when program update is ended.

8. The system according to claim 6, wherein if said client apparatus is executing a job at the time of data reception by said reception unit, said update unit executes program update after the job that is being executed is ended.

9. The system according to claim 6, wherein if said client apparatus is executing a job at the time of data reception by said reception unit, said update unit requests said server apparatus to reschedule program update.

10. The system according to claim 6, wherein said client apparatus comprises a first return unit configured to return said second data processing apparatus from a power saving state in accordance with the schedule determined by said scheduling unit.

11. The system according to claim 6, wherein said client apparatus comprises a second return unit configured to return said first data processing apparatus from a power saving state in accordance with the schedule determined by said scheduling unit.

12. The system according to claim 6, wherein the job execution status representing the number of jobs executed in each of a plurality of periods of time by said client apparatus.

13. A data processing method for a server apparatus for transmitting data necessary for program update to a client apparatus, comprising the steps of:
acquiring, from said client apparatus, job execution status representing the status of jobs executed in each of a plurality of periods of time by said client apparatus; and
determining a schedule of program update in said client apparatus on the basis of the job execution status acquired in the acquiring step.

14. The method according to claim 13, wherein in the scheduling step, one of a period of time with minimum job execution and a period of time without job execution in said client apparatus is detected on the basis of the job execution status acquired in the acquiring step, and the schedule of program update is determined on the basis of the detected time.

15. The method according to claim 13, wherein
in the acquiring step, the job execution status is acquired from each of a plurality of client apparatuses, and
in the scheduling step, the schedule of program update in each of the plurality of client apparatuses is determined on the basis of the job execution status acquired from the plurality of client apparatuses in the acquiring step not to make the plurality of client apparatuses execute program update in the same period of time.

16. The method according to claim 13, further comprising the step of transmitting data necessary for program update in said client apparatus in accordance with the schedule of program update determined in the scheduling step.

17. The method according to claim 13, wherein the job execution status representing the number of jobs executed in each of a plurality of periods of time by said client apparatus.

18. A computer-readable storage medium storing a computer program for a server apparatus for transmitting data necessary for program update to a client apparatus, comprising:
an acquisition module which acquires, from said client apparatus, job execution status representing the status of jobs executed in each of a plurality of periods of time by said client apparatus; and
a scheduling module which determines a schedule of program update in said client apparatus on the basis of the job execution status acquired by said acquisition module.

19. The medium according to claim 18, wherein said scheduling module detects one of a period of time with minimum job execution and a period of time without job execution in said client apparatus on the basis of the job execution status acquired by said acquisition module, and determines the schedule of program update on the basis of the detected time.

20. The medium according to claim 18, wherein
said acquisition module acquires the job execution status from each of a plurality of client apparatuses, and
said scheduling module determines the schedule of program update in each of the plurality of client apparatuses on the basis of the job execution status acquired from the plurality of client apparatuses by said acquisition module not to make the plurality of client apparatuses execute program update in the same period of time.

21. The medium according to claim 18, further comprising a transmission module which transmits data necessary for program update in said client apparatus in accordance with the schedule of program update determined by said scheduling module.

22. The medium according to claim 18, wherein the job execution status representing the number of jobs executed in each of a plurality of periods of time by said client apparatus.
